(19) United States
(12) Patent Application Publication
(10) Pub. No.: US 2007/0160078 A1
(43) Pub. Date: Jul. 12, 2007

(54) Ethernet component

(75) Inventors: Chih-Tse Chen, Taoyuan Hsien (TW); Ching-Man Kao, Taoyuan Hsien (TW); Han-Cheng Hsu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/651,002

(22) Filed: Jan. 9, 2007

(30) Foreign Application Priority Data
Jan. 11, 2006 (TW) 095200631

(51) Int. Cl. H04L 12/66

(52) U.S. Cl. 370/463

(57) ABSTRACT

An ethernet component includes a case, a data processing unit and a circuit device. The case has a plurality of first pins and a plurality of second pins. The data processing unit is disposed in the case and is electrically connected with the first pins. The circuit device is connected with the data processing unit through the second pins.

### BACKGROUND OF THE INVENTION

1. Field of Invention

The present invention relates to a network component, and more particularly, to an ethernet component.

2. Related Art

Accompanying with the development of technology, the required data can be rapidly acquired through cable network or wireless network. The demands of transmitting rate and receiving rate to data are thus raised. The network device is shrunk in order to meet the requirement of small scale of electronic products.

As shown in FIG. 1, a conventional ethernet device includes a main board 11, a connector module 12 and a network element 13. Data can be received by the connector module 12 and then be transformed by the network element 13. When the ethernet device is used, a circuit board 14 is needed to receive an exterior power. The exterior power is transformed into proper power providing to the ethernet device.

Due to the circuit board 14 does not provide input or output pins, the circuit board 14 is electrically connected with the main board 11 through a plurality of wires 141 for providing power to the connector module 12 and the network element 13. However, the connection of the wires 141 is not easy and wastes labor power and time. When the ethernet device is used at client, the circuit board 14 is also need to connect with the ethernet device. The dimension of the circuit board 14 needs to be shrunk if the client can not provide enough space, the cost is thus increased. In addition, because the internal circuit of the circuit board 14 is fixed, it is hard to change the internal circuit of the circuit board 14 for adding more functionality.

It is thus imperative to provide an ethernet component capable of meeting the requirement of small scale, and easy design and connection.

### SUMMARY OF THE INVENTION

In view of the foregoing, the present invention provides an ethernet component capable of meeting the requirement of small scale, shortening data transmission path to speed-up data processing rate, and performing design and connection in accordance with actual requirement.

To achieve the above, an ethernet component according to the present invention includes a case, a data processing unit and a circuit device. The case has a plurality of first pins and a plurality of second pins. The data processing unit is disposed in the case and is electrically connected with the first pins. The circuit device is electrically connected with the data processing unit through the second pins.

As mentioned above, an ethernet component according to the present invention integrates a circuit device and a power receiving unit into a case. The ethernet component rapidly transforms network data by a data processing unit, and the transformed network data are promptly transmitted to the data processing unit for processing the network data. The power receiving unit receives an exterior power, and the circuit device rapidly transforms the power into a proper power providing to the ethernet component so that the application of power over ethernet (POE) is achieved. Compared with the conventional ethernet device, the small-scaled power receiving unit and the small-scaled circuit device of the present invention integrated into the case can rapidly transform the power into a proper power providing to subsequent circuit when the ethernet component is used at client. Furthermore, it is space-saving and meets the requirement of small scale of electronic products. The data processing unit is electrically connected with the first pins so that the received network data can be processed in real-time, and which shortening data transmission path to speed-up data processing rate. In addition, the circuit or a control element of the circuit device is easily changed if the functionality needs to be increased by client. Design and connection in accordance with actual requirement are performed more manpower-saving and time-saving.

### BRIEF DESCRIPTION OF THE DRAWINGS

The present invention will become more fully understood from the detailed description given herein below illustration only, and thus are not limitative of the present invention, and wherein:

FIG. 1 is a schematic diagram showing a conventional ethernet device;

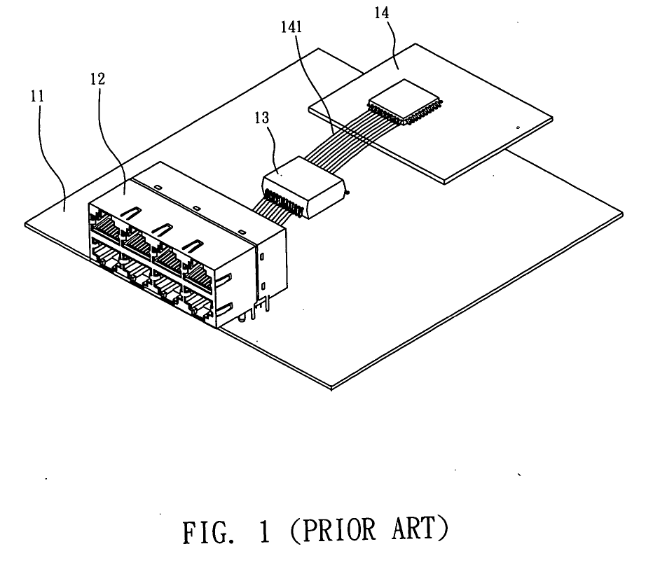

FIG. 2 is an exploded diagram showing an ethernet component according to a preferred embodiment of the present invention;

FIG. 3 is a combined diagram showing the ethernet component according to the preferred embodiment of the present invention; and

FIG. 4 is a schematic diagram showing the ethernet component according to the preferred embodiment of the present invention, which connects with a second circuit device and the connector thereon.

### DETAILED DESCRIPTION OF THE INVENTION

The present invention will be apparent from the following detailed description, which proceeds with reference to the accompanying drawings, wherein the same references relate to the same elements.

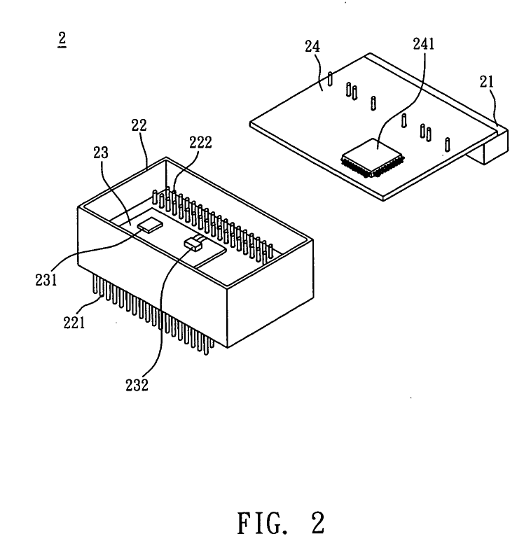

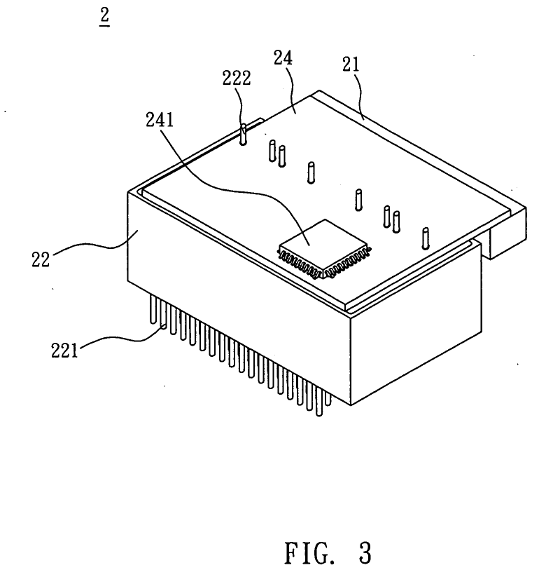

FIGS. 2 and 3 are respectively an exploded diagram and a combined diagram showing an ethernet component 2 according to a preferred embodiment of the present invention. As shown in FIGS. 2 and 3, the ethernet component 2 includes a power receiving unit 21, a case 22, a data processing unit 23 and a first circuit device 24.

The power receiving unit 21 receives an exterior power and transmits the power to the first circuit device 24. The first circuit device 24 has a control element 241. The control element 241 can be a processor. The first circuit device 24 can be a circuit board.

The case 22 has a plurality of first pins 221 and a plurality of second pins 222. The first pins 221 are for receiving exterior network data. In this embodiment, the case 22 is made of insulating material such as plastic.

The data processing unit 23 includes a data processing element 231 and a transformer 232. The data processing element 231 is electrically connected with the transformer 232. The data processing unit 23 is disposed in the case 22 and is electrically connected with the plurality of first pins 221. In this embodiment, the first pins 221 of the case 22 receives and transmits exterior network data to the data processing unit 23, and the exterior network data are processed by the data processing element 231.

When the power receiving unit 21 receives the exterior power and transmits the power to the first circuit device 24, the first circuit device 24 modulates the exterior power by the control element 241 and transmits the modulated power to the transformer 232 through the second pins 222. The transformer 232 transforms the modulated power into a proper power providing to the data processing unit 23.

As shown in FIG. 3, the first circuit device 24 is connected with the case 22 through the second pins 222. The power receiving unit 21 is disposed adjacent to the case 22.

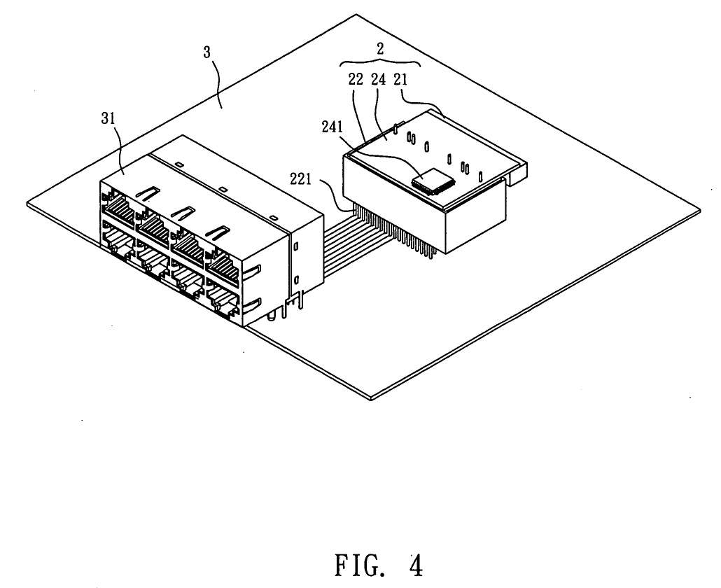

As shown in FIG. 4, the ethernet component 2 is disposed on a second circuit device 3. The second circuit device 3 can be a circuit board and is electrically connected with at least one connector 31. The connector 31 receives and transmits exterior network data to the ethernet component 2 through the second circuit device 3. The connector 31 can be a RJ-11 connector, a RJ-12 connector or a RJ-45 connector.

In summary, an ethernet component according to the present invention integrates a circuit device and a power receiving unit into a case. The ethernet component rapidly transforms network data by a data processing unit, and the transformed network data are promptly transmitted to the data processing unit for processing the network data. The power receiving unit receives an exterior power, and the circuit device rapidly transforms the power into a proper power providing to the ethernet component so that the application of power over ethernet (POE) is achieved. Compared with the conventional ethernet device, the small-scaled power receiving unit and the small-scaled circuit device of the present invention integrated into the case can rapidly transform the power into a proper power providing to subsequent circuit when the ethernet component is used at client. Furthermore, it is space-saving and meets the requirement of small scale of electronic products. The data processing unit is electrically connected with the first pins so that the received network data can be processed in real-time, and which shortening data transmission path to speed-up data processing rate. In addition, the circuit or a control element of the circuit device is easily changed if the functionality needs to be increased by client. Design and connection in accordance with actual requirement are performed more manpower-saving and time-saving.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. An ethernet component, comprising:
a case having a plurality of first pins and a plurality of second pins;
a data processing unit disposed in the case and electrically connected with the first pins; and
a first circuit device connected with the case through the second pins.

2. The ethernet component according to claim 1, further comprising a power receiving unit electrically connected with the first circuit device for receiving an exterior power.

3. The ethernet component according to claim 2, wherein the first circuit device receives and transmits the power to the data processing unit through the second pins.

4. The ethernet component according to claim 2, wherein the first circuit device further comprises a control element for controlling the power.

5. The ethernet component according to claim 4, wherein the control element is a processor.

6. The ethernet component according to claim 1, wherein the first circuit device is a circuit board.

7. The ethernet component according to claim 1, wherein the first pins are for receiving exterior network data.

8. The ethernet component according to claim 7, wherein the data processing unit comprises a data processing element for processing the exterior network data.

9. The ethernet component according to claim 8, wherein the data processing unit further comprises a transformer electrically connected with the data processing element.

10. The ethernet component according to claim 1, wherein the case is made of plastic or an insulating material.

11. The ethernet component according to claim 1, wherein the ethernet component is disposed on a second circuit device.

12. The ethernet component according to claim 11, wherein the second circuit device is a circuit board.

13. The ethernet component according to claim 11, wherein the second circuit device comprises at least one connector for receiving exterior network data which are transmitted to the ethernet component through the second circuit device.

14. The ethernet component according to claim 13, wherein the connector is a RJ-11 connector.

15. The ethernet component according to claim 13, wherein the connector is a RJ-12 connector.

16. The ethernet component according to claim 13, wherein the connector is a RJ-45 connector.
